(19) United States
(12) Patent Application Publication
(10) Pub. No.: US 2013/0083668 A1
(43) Pub. Date: Apr. 4, 2013

(54) COMMUNICATION DEVICE, COMMUNICATION METHOD, AND COMPUTER READABLE MEDIUM

(71) Applicants: Yuichiro OYAMA, Tokyo (JP); Takeshi Ishihara, Yokohama-shi (JP); Yoshimichi Tanizawa, Yokohama-shi (JP)

(72) Inventors: Yuichiro OYAMA, Tokyo (JP); Takeshi Ishihara, Yokohama-shi (JP); Yoshimichi Tanizawa, Yokohama-shi (JP)

(21) Appl. No.: 13/537,352

(22) Filed: Jun. 29, 2012

(30) Foreign Application Priority Data
Sep. 30, 2011 (JP) 2011-218678

(51) Int. Cl. H04L 12/26

(52) U.S. Cl. 370/242

(57) ABSTRACT

In one embodiment, there is provided a communication device including: a storage configured to store transmission packets and expected reply results; a controller configured to transmit the transmission packets to a network and to detect reply results corresponding to the transmission packets from the network; and a determination module configured to determine whether or not each of the reply results matches a corresponding one of the expected reply results. When the determination module determines that a reply result corresponding to one of the transmission packets matches a corresponding expected reply result, the controller continues to transmit another one of the transmission packets to the network and to detect a reply result corresponding to said another one of the transmission packets. When the determination module determines that the reply result does not match the corresponding expected reply result, the controller stops transmitting the remaining transmission packets to the network.

This application claims priority from Japanese Patent Application No. 2011-218678, filed on Sep. 30, 2011, the entire contents of which are hereby incorporated by reference.

### BACKGROUND

1. Field

Embodiments described herein relate to a communication device, a communication method, and a computer readable medium.

2. Description of the Related Art

For the purpose of reducing power consumption in the standby mode of network equipment, a technique is known in which the network equipment transitions to a sleep mode where some functions are disabled. In the sleep mode, if the network functions are disabled, the network equipment does not reply to an inquiry from the outside.

### BRIEF DESCRIPTION OF THE DRAWINGS

FIG. 1 is a block diagram showing the configuration of a communication device 100 according to a first embodiment;

FIG. 2 is a diagram showing an example of information which is stored in a storage 112 of the communication device 100;

FIGS. 3A and 3B are diagrams showing comparison between the operations of a first processor 101 and a second processor 110 when a network return process by the second processor 110 is successful and when the network return process fails;

FIG. 4 is a flowchart showing a return process which is executed by a controller 111 of the communication device 100;

FIG. 5 is a diagram showing an example of a process sequence when the communication device 100 executes a network return process using information of FIG. 2;

FIG. 6 is a diagram showing comparison portions and information which is stored in the storage 112 of the communication device 100;

FIG. 7 shows a state that a reception packet which is stored in the storage 112 of FIG. 2 is stored in a state where bits excluded from a comparison target are masked;

FIG. 8 is an operation sequence diagram between the components of the communication device 100;

FIG. 9 is a block diagram showing the configuration of a communication device 900 according to a second embodiment;

FIG. 10 shows an example of information which is used to decide a process sequence when the communication device 900 executes a network return process;

FIGS. 11A and 11B are diagrams showing an example where a method of deciding a process sequence when the communication device 900 executes a network return process is decided and stored in the storage 112;

FIG. 12 is a block diagram showing the configuration of a communication device 1200 according to a third embodiment;

FIG. 13 is a block diagram showing the configuration of a communication device 1300 according to a fourth embodiment; and

FIG. 14 is a flowchart of an analyzer 1312 of the communication device 1300.

### DETAILED DESCRIPTION

According to exemplary embodiments of the present invention, there is provided a communication device. The communication device includes: a storage configured to store transmission packets and expected reply results for the transmission packets such that each of the transmission packets is associated with a corresponding one of the expected reply results; a controller configured to transmit the transmission packets to a network and to detect reply results corresponding to the transmission packets from the network; and a determination module configured to determine whether or not each of the reply results matches a corresponding one of the expected reply results. When the determination module determines that a reply result corresponding to one of the transmission packets matches a corresponding expected reply result, the controller continues to transmit another one of the transmission packets to the network and to detect a reply result corresponding to said another one of the transmission packets. When the determination module determines that the reply result does not match the corresponding expected reply result, the controller stops transmitting the remaining transmission packets to the network.

Hereinafter, embodiments of the invention will be described with reference to the drawings. In the drawings, the same parts are represented by the same reference numerals, and overlapping description will be omitted.

### First Embodiment>

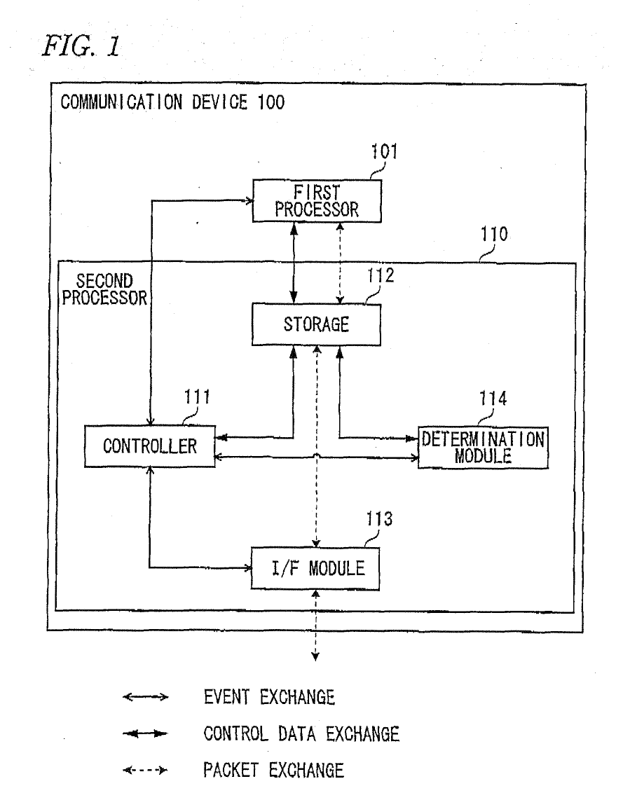

FIG. 1 shows the configuration of a communication device 100 according to a first embodiment of the invention,

The communication device 100 includes a first processor 101 on which application software or an OS operates, and a second processor 110 which has a function of connecting the communication device 100 to the network and a function of executing a return process relating to the network from among return processes.

The second processor 110 includes a controller 111 which controls the operation of the second processor 110, a storage 112 which stores various kinds of information for the operation of the second processor 110, an interface module (IF module) 113 which is used for connection to the external network, and a determination module 114 which determines whether or not information received from the network matches information stored in the storage 112.

The controller 111 may be a microcomputer on which a general-purpose program runs or may be a dedicated circuit on which only a predetermined logic runs. Any format may be used as long as the following functions can be realized.

The communication device 100 transitions between an active mode and a sleep mode. In the sleep mode, the number of functions to be used from among the functions of the communication device 100 decreases to reduce power consumption compared to the active mode. For example, in the sleep mod; the communication device 100 does not use the functions of the first processor 101 and the second processor 110

When the communication device 100 is in the active mod; the first processor 101 is connected to the network through the second processor 110. In the active mode, the first processor 101 stores information to be transmitted to the network in the storage 112, and the controller 111 transmits the stored information from the interface module 113 to the network. Conversely, information received from the network is stored in the storage 112 through the interface module 113, and the controller 111 notifies this effect to the first processor 101. In this way, one of the operations of the second processor 110 refers to an operation as a network interface with respect to the first processor 101.

When the communication device 100 is in the active mode, the first processor 101 notifies the second processor 110 of a pair of an L2 frame or an L3 packet, which is transmitted to update the network setting, and an L2 frame or an L3 packet (hereinafter, all are referred to as packets), which is expected as a reply, and related information. The second processor 110 stores the notified pair of packets in the storage 112. Examples of a packet pair to be stored include ARP Request-ARP Reply, DHCP Discover-DHCP Offer, DHCP Request-DHCP ACK, Neighbor Discovery, SSDP Advertisement, and the like. The examples are not intended to limit a packet pair to be stored. All packets relating to the network setting may be used. Single transmission and a plurality of reception packets may be stored in pairs. When a plurality of reception packets are stored, the relation between the reception packets is also stored. That is, all packets are expected to be received, only one from among a plurality of reception packets is expected to be received, or the like. There may be no reception packet as a reply (Neighbor Discovery or SSDP Advertisement which is transmitted at the time of network initialization has no reply in the normal state). As described above, since data which is stored in the storage 112 always includes information “not received”, not the reception packet, it is assumed that data which is stored in the column “reception packet” is called an expected reply result.

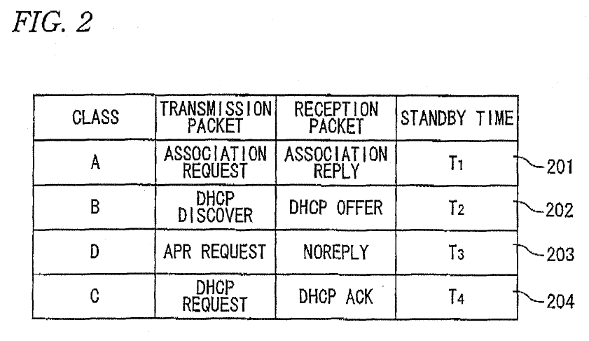

FIG. 2 shows an example of information which is stored in the storage 112. In a table of FIG. 2, one entry is stored in one row. An entry stores “class” of a packet pair “packet pair”, and “standby time” from when a transmission frame is transmitted until a reply frame is received. The “class” of a packet pair is an identifier which is decided between the first processor 101 and the second processor 110 in advance. This identifier allows a packet pair transmitted and received at the time of network re-initialization to be uniquely identified. In this embodiment, the first processor 101 notifies the second processor 110 in a form in which the class is specified.

With regards to a packet pair, in the row 201, a frame which is transmitted to establish association with an access point of IEEE 802.11 and a reply are stored. Similarly, in the row 202, a packet for finding a DHCP server and a reply are stored. In the row 203, ARP Request which is transmitted to check whether or not an IPv4 address attempted for use is duplicated on the network and a symbol (NOREPLY) indicating that a reply is not returned are stored. In the row 204, a packet which requires an address for the found DHCP server and a reply are stored.

The storage 112 may store a transmission packet and a reception packet as a reply or may store the addresses of the memory where the packets are stored.

In the storage 112, like the entry of the row 203, it is normal that there is no reply to a packet which is transmitted when a network return process is executed. In this case, a special symbol (in this example, NOREPLY) is stored to be distinguishable. The value which is stored as the standby time changes in interpretation depending on the presence/absence of a reception frame. When a reception frame is set, the standby time is interpreted as the standby time until the frame is received. That is, if no reply is obtained for the time stored in this field, this is regarded as return failure. When it is normal that no reply is obtained; the standby time is interpreted as the standby time until it is confirmed that there is no reply. That is, when a reply is received for the time stored in this field, this is regarded as return failure. When a reception packet is not specified, the standby time may be set to 0 (zero). In this case, it is necessary to transmit only a predetermined packet during the return process.

The first processor 101 may notify information to the storage 112 at an arbitrary timing. For example, when the process is normally completed in the first processor 101, “class” specifying the process, packets transmitted and received during the process, and the standby time are stored in the storage 112. At this time, the packets which have been used during the process may be stored as they are, or may be stored after some fields are changed for a subsequent process. In regard to the changes for a subsequent process, for example, when a packet includes a sequence number, the packet may be stored after the number increases. For example, when a packet includes a time, the packet may be stored after the time is corrected to the expected time at which the packet will be transmitted subsequently. A checksum or the like depending on these changes is also appropriately corrected.

When the communication device 100 transitions to the standby mode (sleep mode) for power saving, the first processor 101 and the second processor 110 transition to the standby mode together. At this time, the content stored in the storage 112 is not lost and can be referenced during a subsequent return process. The configuration of the storage 112 for realizing this function may be made by any method. For example, a volatile memory may be kept in the electrical conduction state using a battery or the like, or a nonvolatile memory may be used.

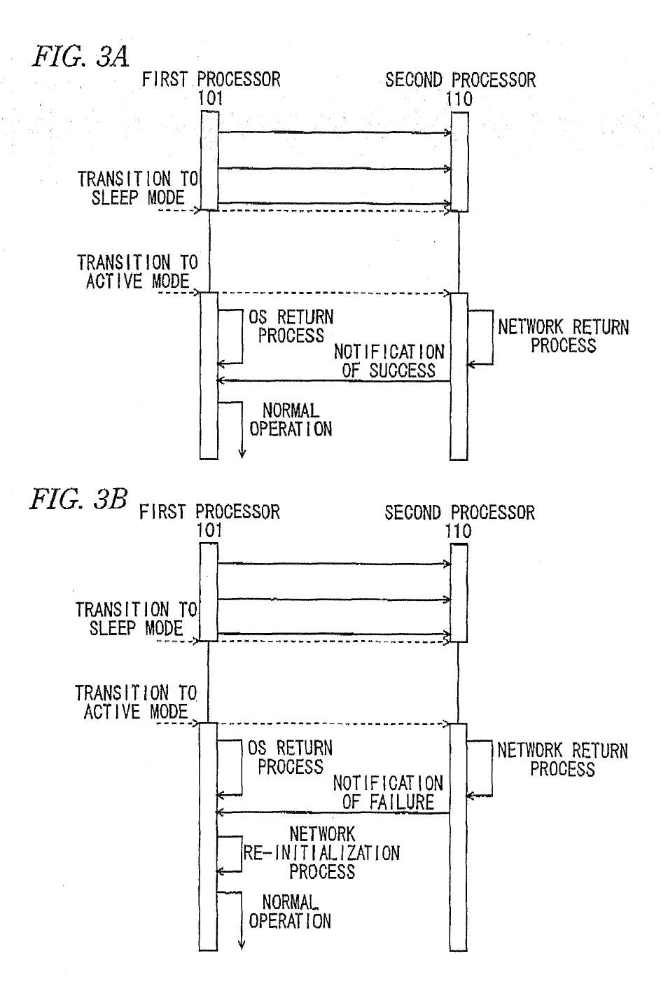

Similarly, when the communication device 100 returns to the active mode, the first processor 101 and the second processor 110 return to the active mode together. The first processor 101 starts the return process of the OS in accordance with an existing technique. The second processor 110 executes the network return process using information stored in the storage 112 parallel with the return process of the OS of the storage 112 separately from the first processor 101. If the network return process ends, the second processor 110 notifies this effect to the first processor 101 regardless of the result. The first processor 101 determines whether the network return process is completed or fails on the basis of the notified result. When the network return process is completed, the first processor 101 continues to be in the active mode. When the network return process fails, a failed portion is specified and the network re-initialization process is executed in accordance with the specification of the communication protocol. With regards to the above sequence, FIG. 3A shows a case where the second processor 110 successfully executes the network return process, and FIG. 3B shows a case where the second processor 110 fails the network return process.

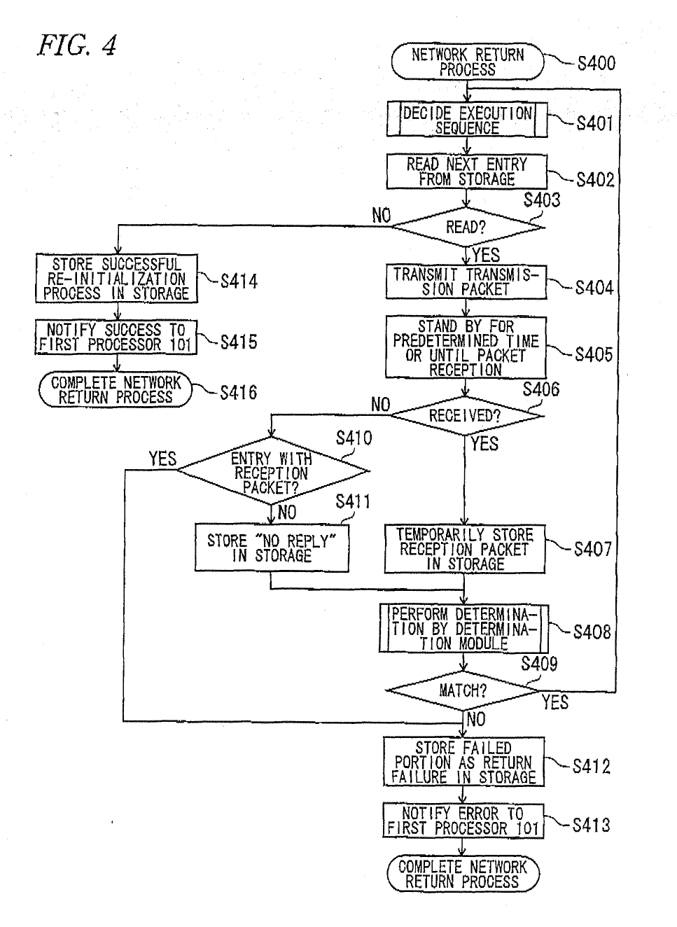

Subsequently, the operation of the second processor 110 will be described in detail. FIG. 4 is a flowchart showing a return process which is executed by the controller 111 of the second processor 110. If an instruction to return the communication device to the active mode is input, the controller 111 references the content of the storage 112 and decides entries to be read (S401). A read sequence decision process for deciding the sequence of the entries to be read will be described below. Thereafter, the controller 111 reads the entries from the storage 112 in accordance with the decided sequence one by one (S402). If there is no entry and read is not performed (S403-NO), this is regarded as that the initialization process normally ends, and this is stored in the storage 112 (S414). Thereafter, a successful return process is notified to the first processor 101 (S415).

When a subsequent entry is read (S403-YES), the controller 111 transmits “transmission packet” included in the entry to the network through the 1/F unit 113 (S404). Thereafter, the communication device stands by for the time specified by “standby time” included in the same entry or until a reply is received (S405). If the standby ends, the reason is confirmed (S406). If the standby ends with the reception of a packet (S406-YES), the reception packet is temporarily stored in the storage 112 (S407). When the standby ends after a predetermined time has elapsed (S406-NO), it is confirmed whether or not an entry being processed is an entry with a reception packet (S410). If the entry being processed is an entry with a reception packet (S410-YES), this is regarded as return process failure and a failed portion is stored in the storage 112 (S412), and then error is notified to the first processor 101 (S413). If the entry being processed is an entry with no reception packet (S410-NO), no reply is recorded in the storage 112 (S411). As described above, it is assumed that reception packet received by the controller 111 or the result that a master packet is “not received” is called a reply result together.

Thereafter, the controller 111 requests the determination module 114 to determine whether or not the value of “reception packet” of the entry stored in the storage 112 and the reply result match each other. The determination module 114 performs the determination and returns the result to the controller 111 (S408). The details of the determination will be described separately.

When the result “match” is notified from the determination module 114 (S409-YES), the process goes to the next entry stored in the storage 112 (returns to S401). When the result “mismatch” is notified (S409-N0), this is regarded as return process failure, a failed portion is stored in the storage 112 (S412) and notified to the first processor 101 (S413), and the process ends.

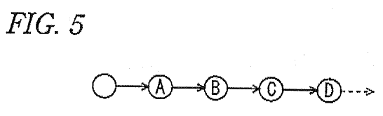

Subsequently, the sequence decision process (S401) which is executed by the controller 111 will be described. The controller 111 has information for defining a return process sequence to execute this decision process. The information for defining the return process sequence refers to the sequence such that the network return process can be realized if the entries of the storage 112 are executed in this sequence. The information may be fixedly provided in the controller 111, or may be notified to the controller 111 when the first processor 101 is in the active mode. The notification may be made once initially, or may be made each time information of the storage 112 is updated. In either case, when executing the sequence decision process, the controller 111 has sequence information which can be uniquely decided. The sequence information is obtained by arranging “class” information of processes which are necessary when the network return process is executed. For example, the sequence information refers to a one-way sequence list (FIG. 5), a tree structure representing the dependence of classes, or the like. The controller 111 references the sequence information and decides the sequence for reading the entries stored in the storage 112. In the one-way sequence list of FIG. 5, transmission frames are transmitted in a sequence of the classes A, B, C, and D shown in FIG. 2 to execute the network re-initialization process.

The above is the read sequence decision process in this embodiment. Although in the flowchart of FIG. 4, the sequence decision process is executed every time, information stored in the storage 112 may be arranged during the initial decision process, such that a single decision process may be executed.

Subsequently, the details of a determination process which is executed by the determination module 114 will be described. When the determination module 114 receives a request for determination from the controller 111, the storage 112 stores a reply result and “reception packet” stored as an entry in advance. The notification includes the storage locations of two packets, and the determination module 114 reads these packets from the storage 112 and compares the packets.

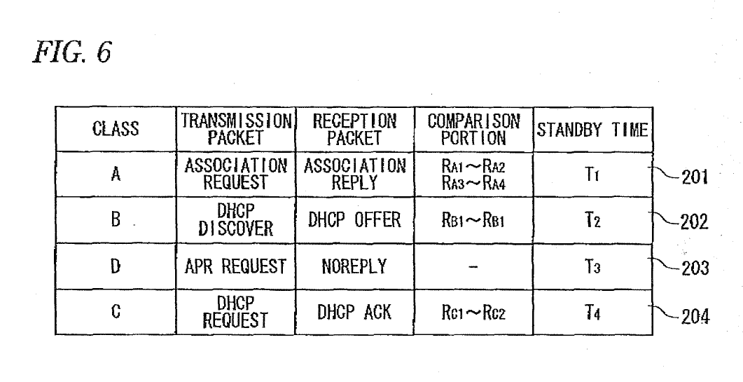

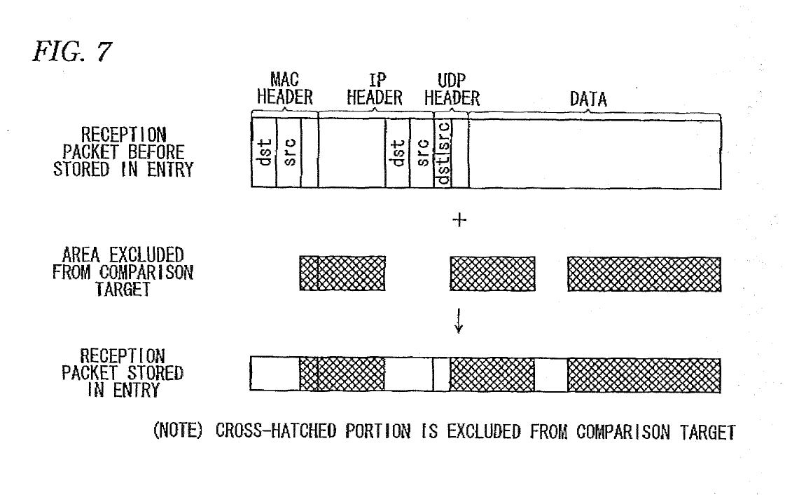

Upon comparison, the entire areas of each packet may be compared, or only portions may be compared. FIGS. 6 and 7 show an example where only portions are compared. In FIG. 6, in addition to the information of the storage 112 of FIG. 2, comparison portions are stored. For example, with regards to the entry of the class A, the comparison portions R_{A1} to R_{A2} and R_{A3} to R_{A4} are compared. FIG. 7 shows a method which stores “reception packet” stored in the entry of FIG. 2 in a state where bits excluded from a comparison target are masked in advance. As in FIG. 7, if “reception packet” of the storage 112 is masked, when comparing the reception packet received from the network and “reception packet” of the storage 112, only unmasked portions are compared.

When “a symbol (NOREPLY) indicating that there is no reception packet” is stored in the entry, this is regarded as that information with no information reception packet is stored in the storage 112. When any packet is recorded, this is regarded as a mismatch. When a plurality of “reception packets” are stored, a match and a mismatch is determined on the basis of the comparison rule. The determination result is returned to the controller 111. As the above-described comparison rule, a plurality of examples may be assumed. For example, as an example of the comparison rule, comparison is done based on whether or not a reply result matches at least one “reception packet”. As another example of the comparison rule, comparison is performed based on whether or not a plurality of reply results match a plurality of “reception packets”.

In this way, in the determination process of the determination module 114, it is determined whether or not information stored in the entry and a received packet match each other under a predetermined condition defined in advance. A complicated protocol process which is executed at the time of normal packet reception is not executed. The above is the process of the determination module 114 in this embodiment.

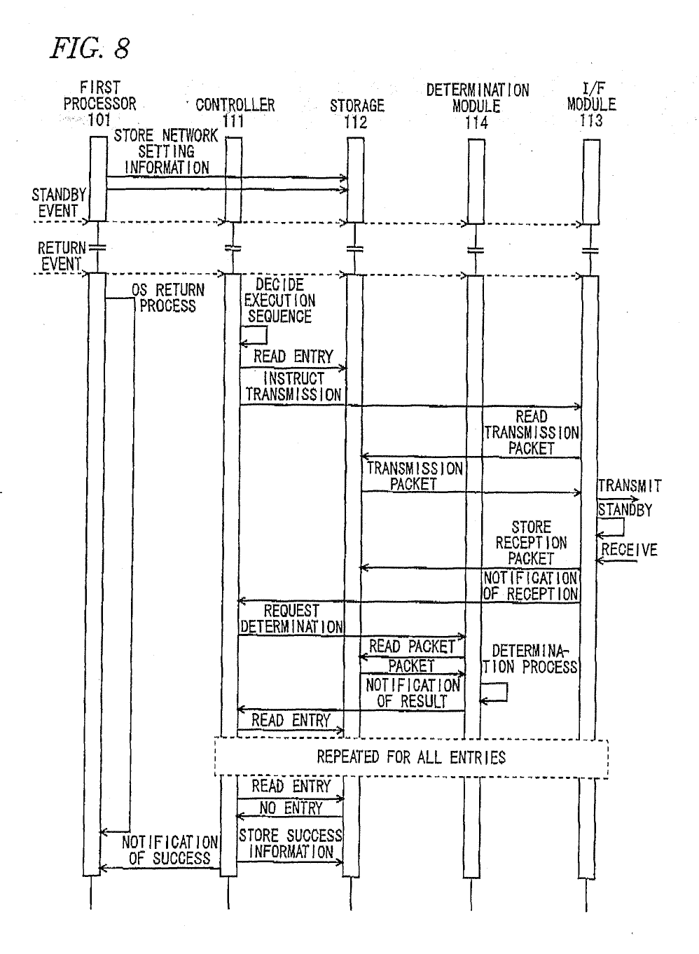

FIG. 8 shows an operation sequence between the components in the first embodiment. The content described in this drawing is as described above, and the details will be omitted.

The above is the flow of the process of the first embodiment. As will be understood from the above, in the embodiment of the invention, a pair of transmission packet and reception packet stored in operation are repeatedly transmitted and received in a sequence suitable for the network return process, thereby executing the return process. At this time, a complicated protocol process is not executed, and the transmission packet stored in the storage 112 is sent in a sequence defined in advance, and the received packet is compared with the packet stored in the storage 112 to perform only the determination of a match and a mismatch, thereby executing the network return process. As a result, it is possible to execute the return process by a simple processor and to reduce the time for the return process. When a mismatch occurs, a main processor (first processor 101) is provided with a function of notifying this effect along with the reason, making it possible to retry the process from a stage where an error occurs. A series of network return processes is executed by the second processor 110 which operates separately from the first processor 101 executing the return process of the OS. Accordingly, it is possible to execute the return process of the OS and the network return process in parallel, thereby realizing a high-speed return process.

For example, the communication device 100 may be realized using a general-purpose computer as basic hardware. That is, the first processor 101 and the second processor 100 (the controller 111, the storage 112, the IF module 113, and the determination module 114) may be realized when a processor mounted in the computer executes a program. At this time, the communication device 100 may be realized by installing the program in the computer in advance, or may be realized by storing the program in a recording medium, such as a CD-ROM, or distributing the program through the network and appropriately installing the program in the computer. The storage 112 may be realized by appropriately using a memory, a hard disk, or a recording medium, such as a CD-R, a CD-RW, a DVD-RAM, or a DVD-R, embedded in or externally attached to the computer.

### Second Embodiment

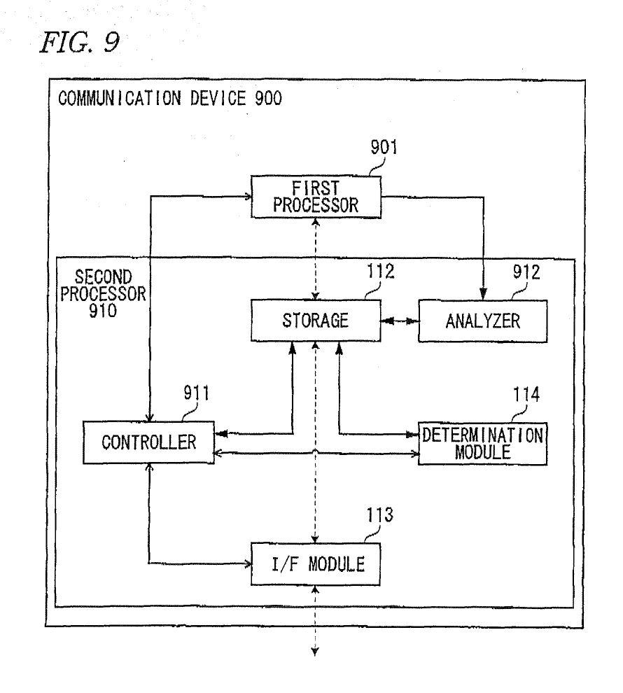

FIG. 9 is a block diagram of a communication device 900 according to a second embodiment

The communication device 900 is different from the communication device 100 of the first embodiment in that an analyzer 912 is further provided and a peripheral portion is correspondingly changed.

In the first embodiment, when the first processor 101 is in the active mode, information (“class” of FIG. 2) stored in the storage 112 is analyzed by the controller 111 at the time of execution to decide the process sequence for the network return process. This embodiment is different from the first embodiment in that information stored in a first processor 901 is analyzed by the analyzer 912, and the analysis result is stored in the storage 112 to obtain a sequence suitable for the return process.

Similarly to the controller 111 of the first embodiment, the analyzer 912 stores information (process dependence) for specifying the process sequence when the network return process is executed.

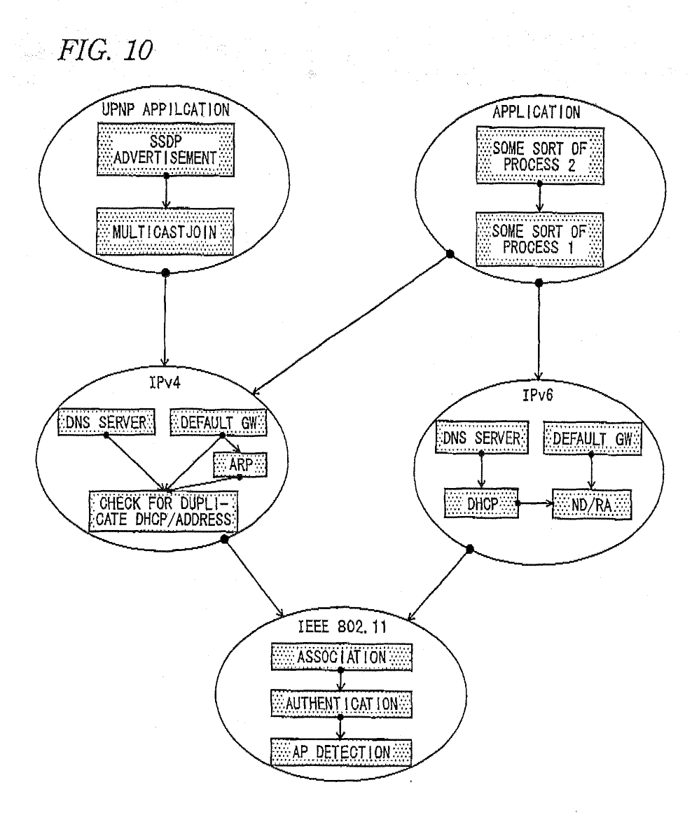

This information may be input in advance or may be input from the outside immediately before operation. FIG. 10 shows an example of information for specifying the process sequence when the network return process is executed. The information shown in FIG. 10 indicates the process sequence dependence in a hierarchical tree structure. In the information shown in FIG. 10, a round end depends on a portion indicated by an arrow. When the return process is executed, if the arrows are traced conversely, the return can be done in a correct sequence. For example, in the return process, the processes in the circle of UPnP Application are executed after the processes in the circle of IPv4. The process SSDP Advertisement from among the processes in the circle of UPnP Application is executed after the process Multicast Join.

Although in the first embodiment, the “class” of information stored in the first processor 101 is specified and stored in the storage 112, in the second embodiment, the class may not be specified. That is the analyzer 912 may specify the “class” of notified information and store the “class” in the storage 112. In this case, the first processor 101 may notify the analyzer 912 of network-related information (for example, transmission/reception packet) set by the first processor 101 without concern as to the sequence or information necessary for the network return process. When notification is made in a state where the “class” is specified, the sequence is just resolved and stored in the storage 112.

Hereinafter, the operation of this embodiment will be described focusing on the difference from the operation of the first embodiment.

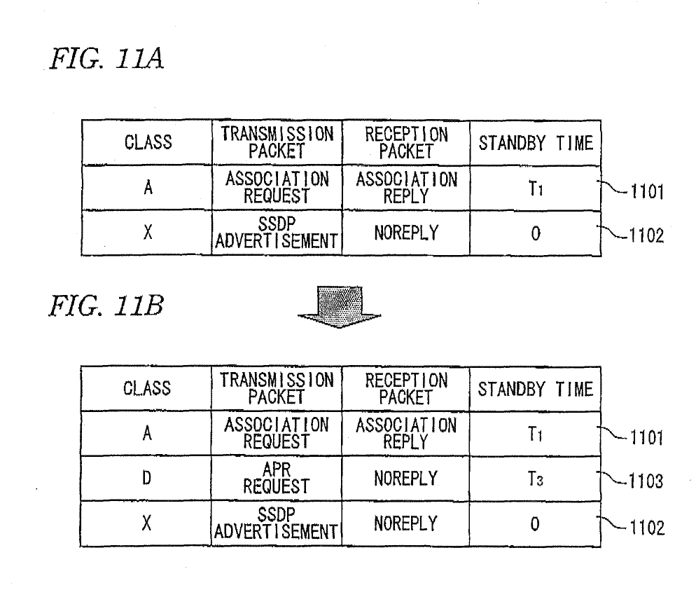

First, the operation of the analyzer 912 will be described. The following operation of the analyzer 912 is performed in the active mode. It is assumed that the analyzer 912 receives a pair of “transmission packet” and “reception packet” from the first processor 901. The, analyzer 912 analyzes these packets and specifies a communication protocol. For example, if the 13th and 14th bytes from the head of the “transmission packet” are 0x0806, it is determined that the communication protocol is ARP. Analysis is continued to confirm the value of a specific field, thereby detecting ARP Request. If it is assumed that the “reception packet” is notified as “NOREPLY”, it can, be determined that the packet pair is an ARP packet for checking a duplicate address on the network (when there is no duplicate address, there is no reply, and when there is a duplicate address, a reply is received). At this time, it is assumed that the storage 112 is in the state of FIG. 11A. It is understood that the packet pair received by the analyzer 912 is a check for duplicate address from the analysis result, and the check for duplicate address corresponds to “check for duplicate DHCP/address” in the circle “IPv4” of FIG. 10. Accordingly, the analyzer 912 may determine that the process corresponding to “check for duplicate DHCP/address” is executable between the row 1101 relating to IEEE 802.11 described in FIG. 11 and the row 1102 relating to UPnP Application from the process dependence of FIG. 10 and the stored process content of FIG. 11. Therefore, information notified from the first processor 901 is arranged in a form of FIG. 11B and stored in the storage 112.

The flowchart of a controller 911 of this embodiment is substantially the same as in the first embodiment. The only difference is that there is no execution sequence decision process in Step S401. In this embodiment, the return process may be executed in a sequence which is stored in the storage 112.

As described above, in this embodiment, the analyzer 912 specifies the class of the notified packet pair, and the dependence is resolved and stored in the storage 112 in an appropriate sequence, thereby reducing processes necessary for the return process to reduce the execution time. Since a complicated process for dependence analysis is executed in the active mode, it is possible to reduce computing resources necessary for the return process. Therefore, it is possible to achieve both a high-speed return process and power saving.

### Third Embodiment

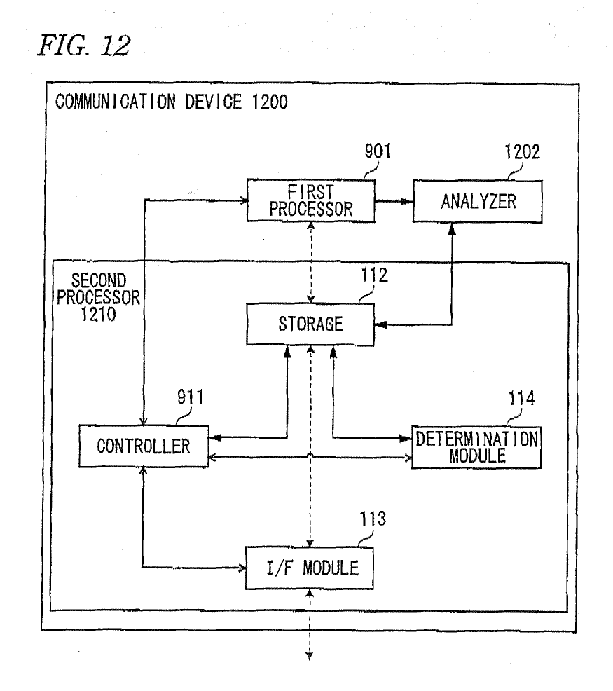

Next, a communication device according to a third embodiment will be described. FIG. 12 is a block diagram showing the configuration of a communication device 1200 according to the third embodiment. The communication device 1200 is different from the communication device 900 of the second embodiment in that an analyzer 1202 is provided outside a second processor 1210. The analyzer 1202 has the same functions as the analyzer 912 described in the second embodiment, and other components of the communication device 1210 have the same functions as the components described in the second embodiment.

The analyzer 1202 may be provided inside the first processor 901, not outside the first processor 901.

According to the configuration of the communication device 1200, it is possible to further reduce computing resources which are required for the second processor 1210.

### Fourth Embodiment

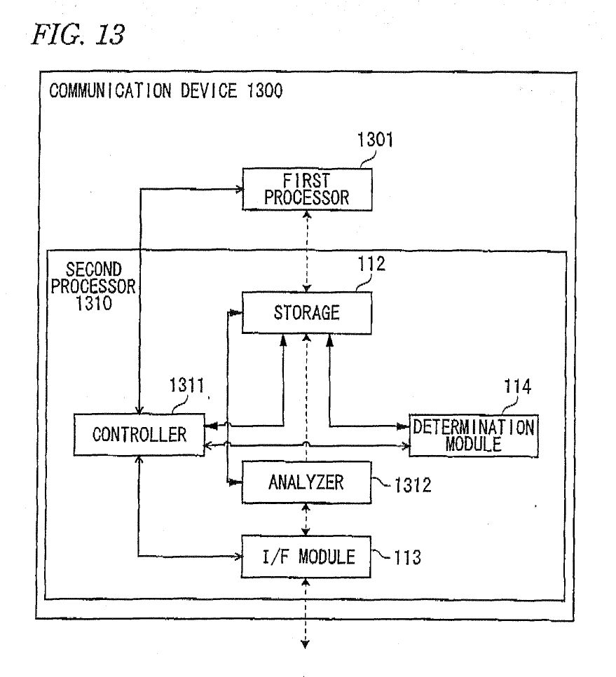

FIG. 13 shows the configuration of a communication device 1300 according to a fourth embodiment. This embodiment is a modification of the second embodiment. In this embodiment, an analyzer 1312 is provided between the storage 112 and the I/F module 113. The analyzer 1312 checks packets which are exchanged between the first processor 1301 and the network and detects packets which are effective for the network return process. The analyzer 1312 also has a function of storing the information in the storage 112. If the analyzer 1312 is provided, it is not necessary for the first processor 1302 to make advance preparation necessary for the network return process. The following description will be provided as to a form in which the analyzer 1312 constantly monitors packets, and the content of the storage 112 is updated. From the viewpoint of low power consumption, an analysis process may be limited to a predetermined timing. At this time, it may be designed such that the analyzer 1312 is powered off, and information can be exchanged directly with the storage 112.

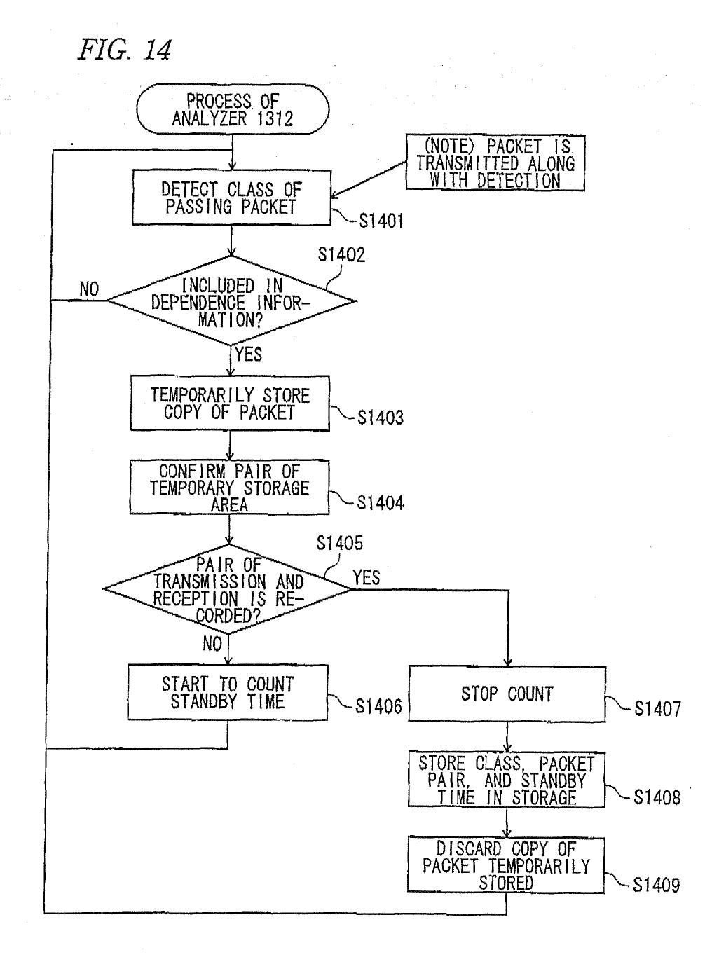

FIG. 14 is a flowchart showing the operation of the analyzer 1312. The analyzer 1312 constantly monitors passing packets (S1401), and determines whether or not the class of a packet is included in the dependence information (see FIG. 10) of the return process stored in advance. When the class is not included (S1402-NO), the monitoring process is executed again (the process returns to S1401). When the class is included (S1402-YES), the packet is copied to a temporary storage area (not shown) to store in the storage 112 (S1403). Thereafter, it is confirmed whether or not both a transmission-side packet and a reception-side packet for the same class are recorded (S1404). If the packets are not recorded (S1405-NO), a count starts to record the standby time (S1406), and the process returns to Step S1401. When the packets are recorded (S1405-YES), the count stops (S1407). Thereafter, the entry having the class, the packet pair, and the standby time is stored in the storage 112 (S1408). Finally, the packet stored in the temporary storage area is discarded (S1409), and the process returns to Step 81401.

The above is the basic operation of the analyzer 1312 of this embodiment. When there are a plurality of reception packets for one transmission packet or when there is no reception packet, the information may be provided in a form of being included in dependence information obtained in advance. The standby time may be included in the information, such that the temporarily stored packet is not retained to be longer than necessary. When the standby time is taken into consideration, the count process which starts in Step S1406 ends at a predetermined standby time. After the count ends, when there is a reception packet as prior information, it is determined that the reception packet is not correctly received, the transmission packet is discarded. When there is no reception packet, an entry may be created using the standby time.

The method in which the analyzer 1312 creates an entry in the storage 112 and other operations of the communication device 1300 are the same as in the second embodiment, thus description thereof will not be repeated.

As the effects of at least one of the foregoing, embodiments, it is possible to realize improvement in the processing speed of the return process from the sleep mode to the active mode of the network equipment.

Although several embodiments of the invention have been described, these embodiments have been presented by way of example only, and are not intended to limit the scope of the invention. The novel embodiments may be embodied in a variety of other forms, and various omissions, substitutions, and changes may be made without departing from the spirit of the invention. The appended claims and their equivalents are intended to cover the modifications or modifications as would fall within the scope and spirit of the invention.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A communication device, comprising:
a storage configured to store transmission packets and expected reply results for the transmission packets such that each of the transmission packets is associated with a corresponding one of the expected reply results;
a controller configured to transmit the transmission packets to a network and to detect reply results corresponding to the transmission packets from the network; and
a determination module configured to determine whether or not each of the reply results matches a corresponding one of the expected reply results,
wherein when the determination module determines that a reply result corresponding to one of the transmission packets matches a corresponding expected reply result, the controller continues to transmit another one of the transmission packets to the network and to detect a reply result corresponding to said another one of the transmission packets, and
wherein when the determination module determines that the reply result does not match the corresponding expected reply result, the controller stops transmitting the remaining transmission packets to the network.

2. The device of claim 1,
wherein the controller is configured to specify classes of the transmission packets and to transmit the transmission packets in a transmission sequence based on the classes.

3. The device of claim 1, further comprising:
a processor configured to operate independently from the controller,
wherein when the transmission packet stops transmitting the remaining transmission packets to the network or when the determination module determines that all of the reply results matches the corresponding expected reply result, the controller notifies the processor.

4. The device of claim 1, further comprising:
a processor configured to operate independently from the controller,
wherein the transmission packets and the expected reply results are obtained based on packets received by the processor from the network or are obtained by modifying the packets received by the processor.

5. The device of claim 3, wherein the communication device is configured to switch between an active mode and a sleep mode whose power consumption is lower than that of the active mode,
wherein the transmission packets and the expected reply results are related to network settings performed when the communication device switches from the sleep mode to the active mode,
wherein the processor executes processes for the network settings, which has not been executed by the controller, when the controller stops transmitting the remaining transmission packets to the network, and
wherein the processor does not execute the processes for the network settings, when the determination module determines that all of the reply results matches the corresponding expected reply result.

6. The device of claim 5,
wherein the controller and the processor start to operate in parallel when the communication device switches from the sleep mode to the active mode.

7. The device of claim 5,
wherein the controller is configured to transmit the transmission packets in a sequence necessary for executing the processes for the network settings.

8. The device of claim 7, wherein the controller determines the sequence based on classes of the transmission packets.

9. A communication method, comprising:
storing transmission packets and expected reply results for the transmission packets in a storage such that each of the transmission packets is associated with a corresponding one of the expected reply results;
transmitting the transmission packets to a network;
detecting reply results corresponding to the transmission packets from the network; and
determining whether or not each of the reply results matches a corresponding one of the expected reply results,
if determining that a reply result corresponding to one of the transmission packets matches a corresponding expected reply result,
continuing to transmit another one of the transmission packets to the network;
detecting a reply result corresponding to said another one of the transmission packets; and
if determining that the reply result does not match the corresponding expected reply result,
transmitting the remaining transmission packets to the network.

10. A non-transitory computer-readable medium storing a program for causing a computer to perform predetermined operations, the operations comprising;
storing transmission packets and expected reply results for the transmission packets in a storage such that each of the transmission packets is associated with a corresponding one of the expected reply results;
transmitting the transmission packets to a network;
detecting reply results corresponding to the transmission packets from the network; and
determining whether or not each of the reply results matches a corresponding one of the expected reply results,
if determining that a reply result corresponding to one of the transmission packets matches a corresponding expected reply result,
continuing to transmit another one of the transmission packets to the network;
detecting a reply result corresponding to said another one of the transmission packets; and
if determining that the reply result does not match the corresponding expected reply result,
transmitting the remaining transmission packets to the network.
